(19) United States
(12) Patent Application Publication
(10) Pub. No.: US 2024/0396583 A1
(43) Pub. Date: Nov. 28, 2024

(54) PHONE CASE SYSTEM AND METHODS OF USE

(71) Applicant: CTB Holdings LLC, Portola Valley, CA (US)

(72) Inventors: Thuan Tran, San Jose, CA (US); Charlie Carroll, Palo Alto, CA (US); Binh Tran, Santa Clara, CA (US)

(21) Appl. No.: 18/667,349

(22) Filed: May 17, 2024

Related U.S. Application Data
(60) Provisional application No. 63/503,942, filed on May 23, 2023.

(51) Int. Cl. H04B 1/3888

(52) U.S. Cl. CPC H04B 1/3888

(57) ABSTRACT

The disclosure includes a phone case system comprising an inner case configured to receive a mobile phone, and an outer case configured to receive the mobile phone and the inner case. In some embodiments, the inner case comprises a flexible material and the outer case comprises a rigid material. The outer case may include a top sidewall configured to move between an open position and a closed position to receive and retain the mobile phone within the outer case. In some embodiments, the phone case system includes a thumb screw configured to detachably couple the top sidewall to a first sidewall of the outer case.

A phone case is often used to provide protection and enhance the functionality of a mobile phone. A phone case may offer an extra layer of protection for mobile phones by safeguarding against scratches, dents, and cracks that can occur from accidental drops, impacts, or everyday wear and tear. Phone cases are commonly constructed of shock-absorbing materials that help cushion the phone and absorb the impact from accidental drops, reducing the risk of damage to the phone's internal components. Phone cases may also include raised edges that help protect the phone's screen and/or camera from scratches when the phone is placed face-down (or camera-side-down) on a rough surface. Phone cases also offer consumers a way to personalize their mobile phones through colors, patterns, and other designs.

While phone cases provide protection, they may not guarantee complete protection against all types of damage. However, using a phone case, especially a durable, well-made case, can significantly reduce the likelihood of damage and prolong the lifespan of a mobile phone.

### SUMMARY

The disclosure includes a phone case system comprising an inner case configured to receive a mobile phone, the inner case comprising a flexible material configured to substantially surround a perimeter and a back surface of the mobile phone, and an outer case configured to receive the mobile phone and the inner case, the outer case comprising a rigid material. In some embodiments, the outer case defines a first sidewall, a second sidewall located opposite the first sidewall, a bottom sidewall extending between the first sidewall and the second sidewall, and a top sidewall located opposite the bottom sidewall and extending between the first sidewall and the second sidewall. The top sidewall may comprise a first end and a second end located opposite the first end, wherein the second end of the top sidewall may be hingedly coupled to the second sidewall. The first end of the top sidewall may be configured to move between an open position and a closed position to receive and retain the mobile phone within the outer case.

In some embodiments, the phone case system further comprises a thumb screw configured to detachably couple the first end of the top sidewall to a first end of the first sidewall. The phone case system may include a plurality of mechanical fasteners configured to couple the second end of the top sidewall to a first end of the second sidewall, couple a second end of the second sidewall to a first end of the bottom sidewall, and couple a second end of the bottom sidewall to a second end of the first sidewall. The plurality of mechanical fasteners may comprise a plurality of hinge pins.

In some embodiments, the first sidewall includes a ridged portion configured to allow a user to hold the outer case. The first sidewall may include a plurality of ridges configured to allow a user to hold the outer case.

The inner case may comprise a first opening located on a first portion of the inner case and a second opening located on a second portion of the inner case. In some embodiments, the second portion is located opposite the first portion. The inner case may also comprise a third opening located on a bottom portion of the inner case. In some embodiments, the first opening and the second opening are configured to enable a user to access a plurality of buttons of the mobile phone, and the third opening is configured to enable the user to access a charging port of the mobile phone.

The outer case may comprise a first opening located on the first sidewall of the outer case and a second opening located on the second sidewall of the outer case. The outer case may also comprise a third opening located on the bottom sidewall of the outer case. In some embodiments, the first opening and the second opening are configured to enable a user to access the plurality of buttons of the mobile phone, and the third opening is configured to enable the user to access the charging port of the mobile phone. The first opening of the inner case may be substantially aligned with the first opening of the outer case, the second opening of the inner case may be substantially aligned with the second opening of the outer case, and the third opening of the inner case may be substantially aligned with the third opening of the outer case. In some embodiments, the phone case system includes a fourth opening located along the top sidewall of the outer case.

In some embodiments, when the mobile phone is coupled to the inner case and the inner case is coupled to the outer case, the outer case is configured to substantially enclose at least the first portion, the second portion, the bottom portion, and a top portion of the inner case. The top portion of the inner case may be located opposite the bottom portion of the inner case. In some embodiments, the outer case defines an open face, thereby allowing the user to contact a front surface of the mobile phone. The outer case may define an open back, thereby allowing the user to contact a back surface of the inner case.

The phone case system may include a first loop hole located along the second sidewall adjacent the top sidewall and a second loop hole located along the bottom sidewall adjacent the first sidewall. In some embodiments, the first loop hole and the second loop hole are each configured to receive an object selected from the group consisting of a keyring, a lanyard, a tether, and combinations thereof.

The inner case may comprise a polymer material. In some embodiments, the outer case comprises a combination of metal and plastic materials.

The disclosure includes a method of using a phone case system comprising coupling a mobile phone to an inner case comprising a flexible material configured to substantially surround a perimeter and a back surface of the mobile phone and coupling the inner case and the mobile phone to an outer case comprising a rigid material. In some embodiments, the outer case defines a first sidewall, a second sidewall located opposite the first sidewall, a bottom sidewall extending between the first sidewall and the second sidewall, and a top sidewall located opposite the bottom sidewall and extending between the first sidewall and the second sidewall. The top sidewall may comprise a first end and a second end located opposite the first end, and the second end of the top sidewall may be hingedly coupled to the second sidewall and configured to move between an open position and a closed position to receive and retain the mobile phone within the outer case.

In some embodiments, coupling the inner case and the mobile phone to the outer case comprises moving the top sidewall to the open position, slideably coupling the inner case and the mobile phone to the outer case through the top sidewall such that the inner case and the mobile phone are substantially encased by the first sidewall, the second sidewall, and the bottom sidewall, and moving the top sidewall to the closed position. Moving the top sidewall from the open position to the closed position may comprise using a thumb screw to detachably couple the first end of the top sidewall to a first end of the first sidewall. In some embodiments, moving the top sidewall from the closed position to the open position comprises removing the thumb screw from the first end of the top sidewall and the first end of the first sidewall.

The foregoing, and other features and advantages of the invention, will be apparent from the following, more particular description of the preferred embodiments of the invention, the accompanying drawings, and the claims.

### BRIEF DESCRIPTION OF THE DRAWINGS

These and other features, aspects, and advantages are described below with reference to the drawings, which are intended to illustrate, but not to limit, the invention. In the drawings, like characters denote corresponding features consistently throughout similar embodiments.

FIG. 1 illustrates a perspective view of a phone case system, according to some embodiments.

FIG. 2 illustrates a perspective view of the phone case system in an open position, according to some embodiments.

FIG. 3 illustrates a perspective view of the phone case system in a closed position, according to some embodiments.

FIG. 4 illustrates a perspective view of the phone case system including a thumb screw, according to some embodiments.

FIG. 5 illustrates a front view of an outer case of the phone case system, according to some embodiments.

FIGS. 6A and 6B illustrate side views of the phone case system, according to some embodiments.

FIGS. 7A and 7B illustrate a bottom view and a top view, respectively, of the phone case system, according to some embodiments.

FIG. 8 illustrates a front view of the phone case system, according to some embodiments.

FIG. 9 illustrates a back view of the phone case system, according to some embodiments.

FIG. 10 illustrates a flowchart of a method of using the phone case system, according to some embodiments.

### DETAILED DESCRIPTION

Phone cases are commonly used to protect mobile phones from damage while enhancing the functionality and/or aesthetics of a mobile phone. For example, a phone case may include a built-in kickstand configured to allow a user to prop up their phone for viewing media, such as to watch a movie or television show while traveling (e.g., on a plane, train, in a vehicle, and the like). Phone cases also come in all colors, shapes, and designs to allow users to reflect their interests and customize their cases to their tastes. Of course, the most basic function of a phone case is protection against scratches, dents, and cracks that can occur from accidental drops, impacts, or everyday wear and tear. Phone cases are available in basic, single-piece construction as well as more advanced multi-piece units. Multi-case systems may offer superior protection by providing multiple layers of shock absorption, though single-piece cases can also offer substantial protection to mobile phones.

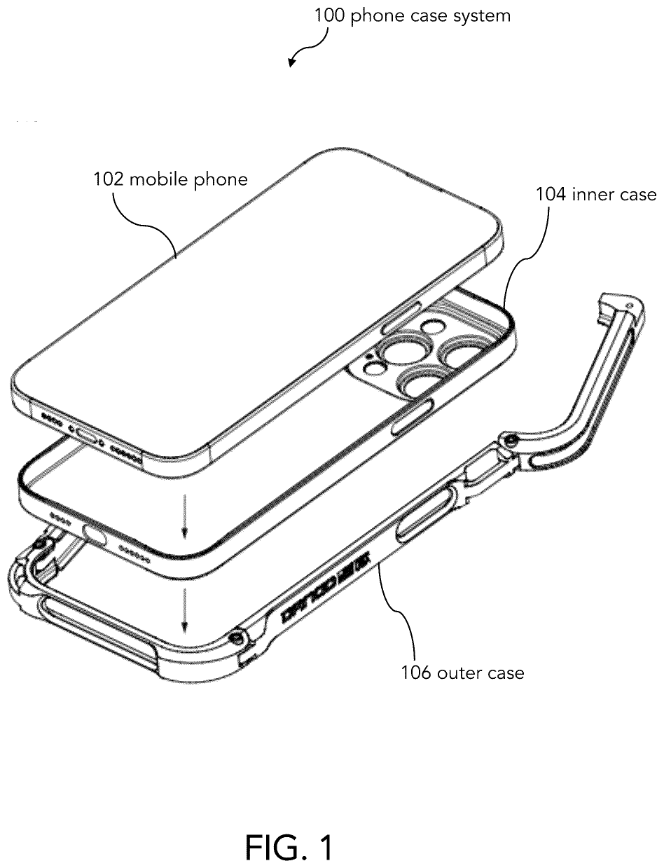

FIG. 1 shows a perspective exploded view of a phone case system 100 including an inner case 104 and an outer case 106. As illustrated in FIG. 1, the inner case 104 may be configured to receive a mobile phone 102, and the outer case 106 may be configured to receive the mobile phone 102 and the inner case 104. In some embodiments, the inner case 104 comprises a flexible material and is configured to substantially surround a perimeter and a back surface of the mobile phone 102. The outer case 106 may comprise a rigid material.

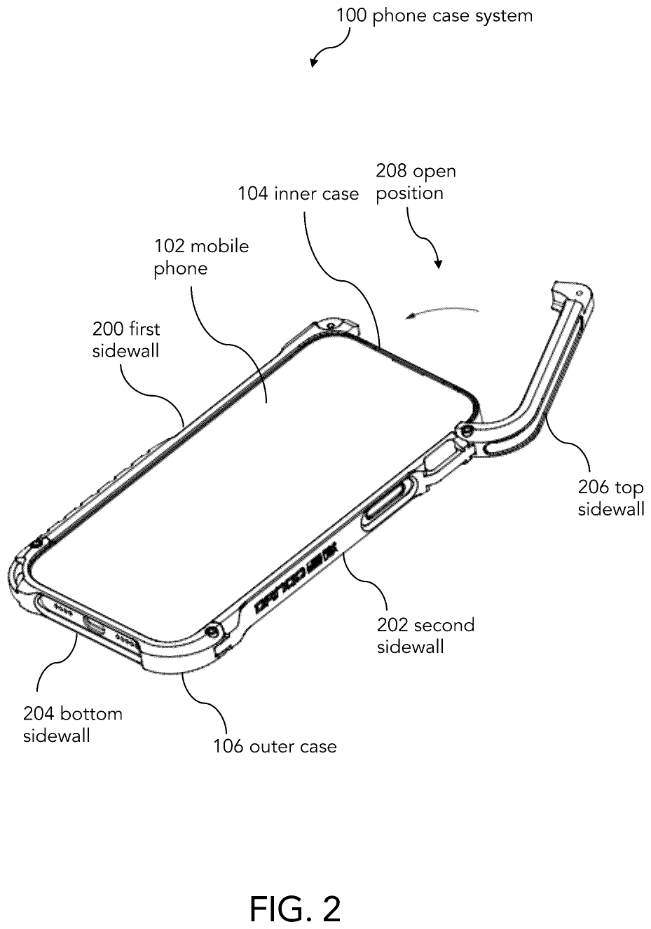

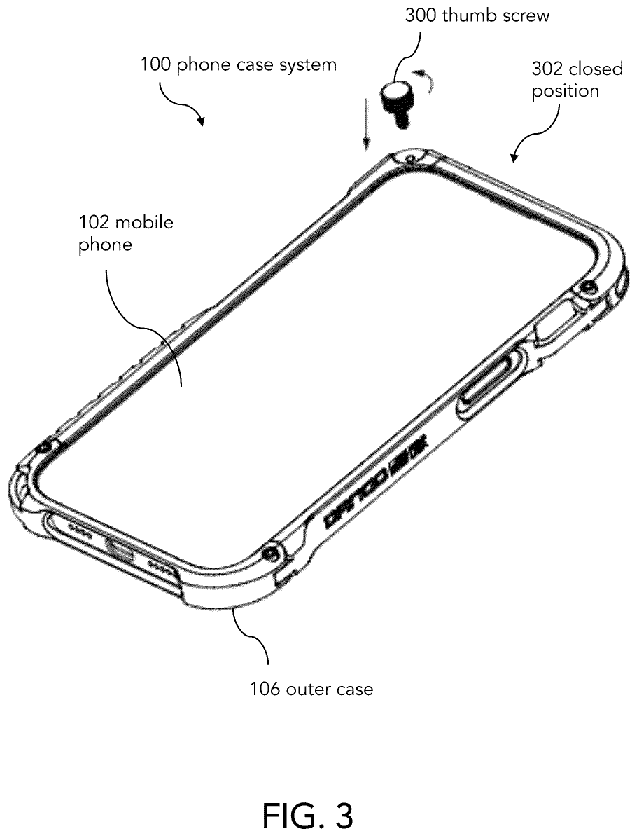

FIG. 2 shows the phone case system 100 with the mobile phone 102 and inner case 104 coupled to the outer case 106. As demonstrated, the outer case 106 may include a first sidewall 200, a second sidewall 202 located opposite the first sidewall 200, a bottom sidewall 204 extending between the first sidewall 200 and the second sidewall 202, and a top sidewall 206 located opposite the bottom sidewall 204 and also extending between the first sidewall 200 and the second sidewall 202. In some embodiments, the top sidewall 206 comprises a first end and a second end located opposite the first end. The second end may be hingedly coupled to the second sidewall 202, as shown in FIG. 2. In some embodiments, the first end of the top sidewall 206 is configured to move between an open position 208, illustrated in FIG. 2, and a closed position 302, illustrated in FIG. 3.

Moving between the open position 208 and the closed position 302 may enable the outer case 106 to receive and retain the mobile phone 102. For example, in the open position 208, the outer case 106 is configured to slideably receive the mobile phone 102 (with or without the inner case 104), and in the closed position 302, the mobile phone 102 (and, possibly, the inner case 104) are retained within the outer case 106, as demonstrated in FIG. 3. In some embodiments, the phone case system 100 includes a thumb screw 300 configured to hold the outer case 106 shut in the closed position 302. To move to the open position 208, a user may simply unscrew and remove the thumb screw 300 and open the top sidewall 206, as shown in FIG. 2.

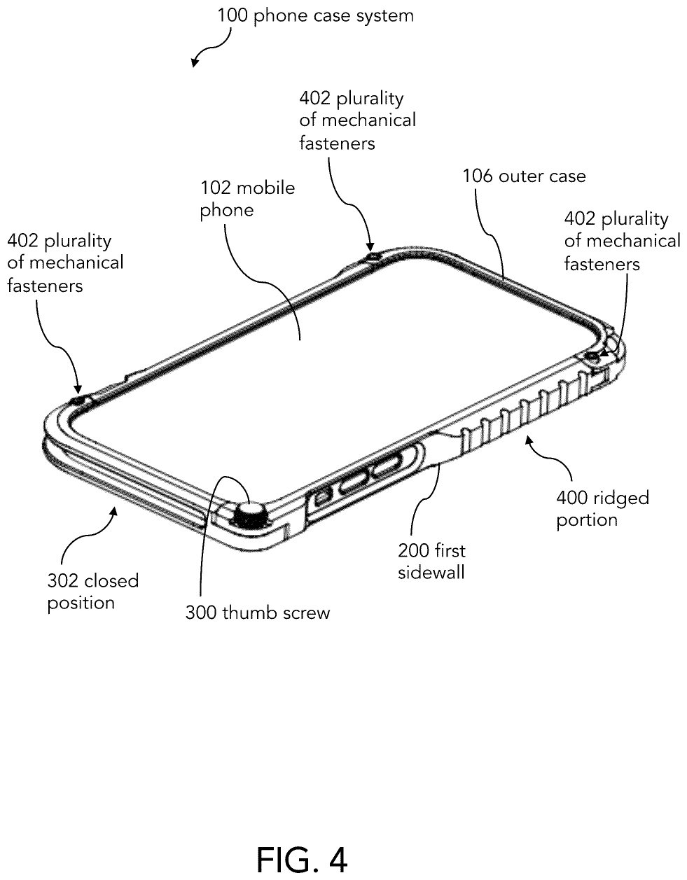

FIG. 4 illustrates a similar view of the phone case system 100 as FIG. 3 but shows the thumb screw 300 fully installed in the outer case 106, with the outer case 106 in the closed position 302. In addition to the thumb screw 300, the phone case system 100 may include a plurality of mechanical fasteners 402 configured to couple the sidewalls to one another. In some embodiments, the plurality of mechanical fasteners 402 comprise a plurality of hinge pins. The plurality of mechanical fasteners 402 may comprise another type of mechanical fastener. FIG. 4 also shows that, in some embodiments, the first sidewall 200 includes a ridged portion 400. The ridged portion 400 may be configured to allow a user to hold the outer case 106. The first sidewall 200 may include a plurality of ridges configured to allow a user to hold the outer case 106.

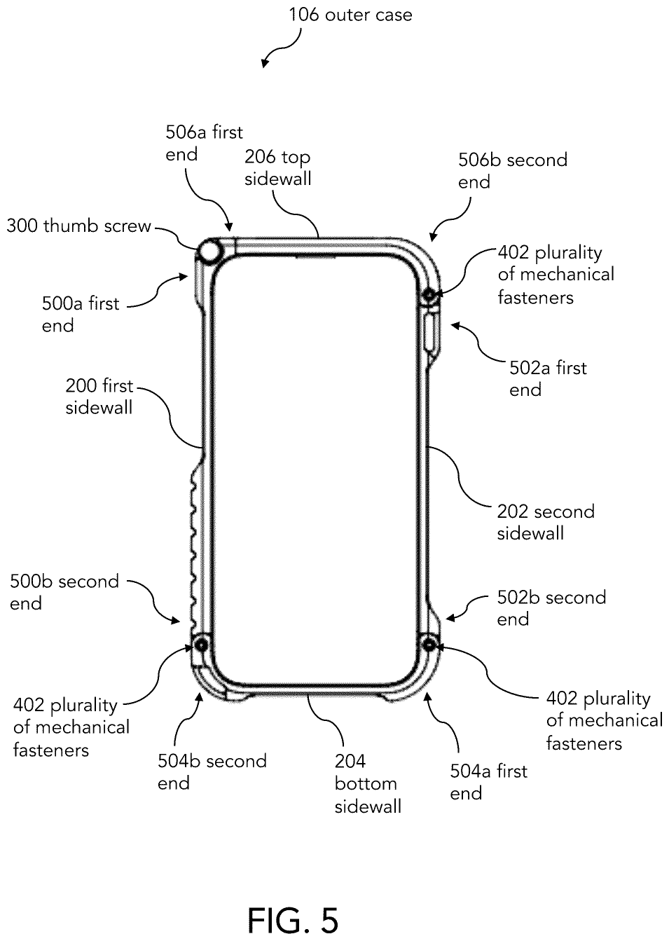

FIG. 5 shows a front view of the outer case 106 and includes each end of each of the first sidewall 200, the second sidewall 202, the bottom sidewall 204, and the top sidewall 206. In some embodiments, the first sidewall 200 includes a first end 500a and a second end 500b located opposite the first end 500a. The second sidewall 202 may include a first end 502a and a second end 502b located opposite the first end 502a. In some embodiments, the bottom sidewall 204 comprises a first end 504a and a second end 504b located opposite the first end 504a. Similarly, the top sidewall 206 may include a first end 506a and a second end 506b located opposite the first end 506a. In some embodiments, the thumb screw 300 is configured to detachably couple the first end 506a of the top sidewall 206 to the first end 500a of the first sidewall 200, thereby enabling the top sidewall 206 to move between the open position 208 and the closed position 302, as previously discussed.

Similar to the thumb screw 300, the plurality of mechanical fasteners 402 may be configured to couple each end of each sidewall. For example, the plurality of mechanical fasteners 402 may be configured to couple the second end 506b of the top sidewall 206 to the first end 502a of the second sidewall 202, the second end 502b of the second sidewall 202 to the first end 504a of the bottom sidewall 204, and the second end 504b of the bottom sidewall 204 to the second end 500b of the first sidewall 200. The plurality of mechanical fasteners 402 may semi-permanently couple the respective ends of the sidewalls 200, 202, 204, 206 such that the sidewalls 200, 202, 204, 206 are securably held together until the plurality of mechanical fasteners 402 are intentionally removed. As previously mentioned, the plurality of mechanical fasteners 402 may comprise a plurality of hinge pins. The plurality of mechanical fasteners 402 may comprise any type of suitable fastener to couple the sidewalls together, including, but not limited to, hinges and bolts.

In some embodiments, the ability to detach the sidewalls 200, 202, 204, 206 from one another enables a user to swap out colors, designs, materials, and the like of each sidewall 200, 202, 204, 206, thereby creating a custom outer case 106. For example, the phone case system 100 may include a first sidewall 200 without the ridged portion 400, a second sidewall 202 with a ridged portion 400, and the like to allow the user to customize the appearance of the outer case 106.

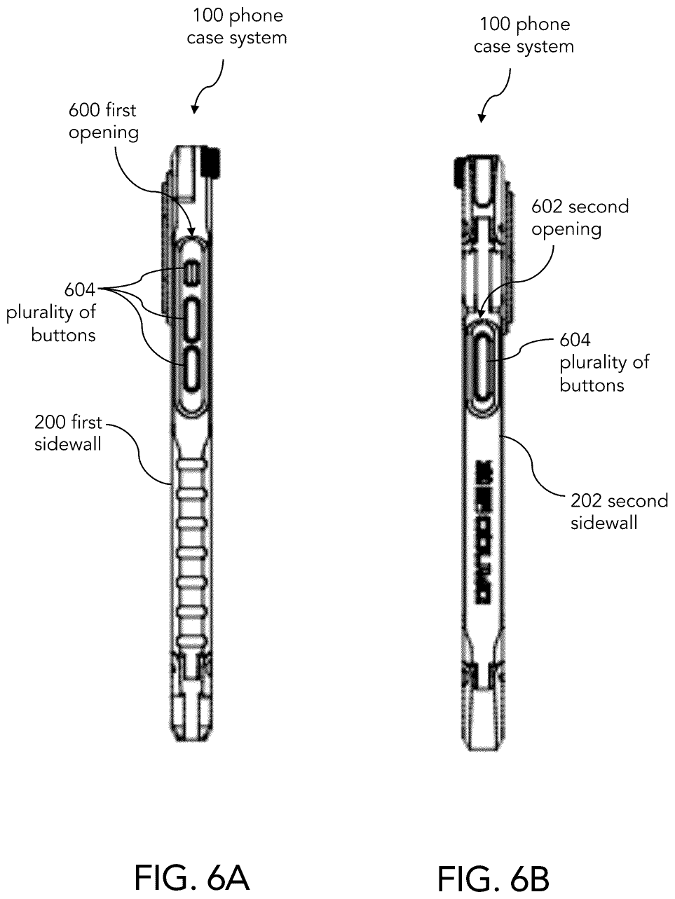

FIGS. 6A and 6B show side views of the phone case system 100. FIG. 6A illustrates that, in some embodiments, the outer case 106 includes a first opening 600 located on the first sidewall 200. Similarly, FIG. 6B shows that, in some embodiments, the phone case system 100 includes a second opening 602 located on the second sidewall 202. The first opening 600 and the second opening 602 may be configured to enable the user to access a plurality of buttons 604 located on the mobile phone 102. In some embodiments, the first opening 600 is configured to provide access to volume buttons and a ringer on/off switch, and the second opening 602 is configured to provide access to a power button. The plurality of buttons 604 may comprise any buttons selected from the group consisting of, but not limited to, volume button(s), home button(s), ringer on/off button(s), and power button(s). The plurality of buttons 604 may also comprise switch(es), button(s), and a combination of the two.

Though not shown in the figures, the inner case 104 may also include a first opening and a second opening configured to enable the user to access the plurality of buttons 604. In some embodiments, the first opening of the inner case 104 is substantially aligned with the first opening 600 of the outer case 106, and the second opening of the inner case 104 is substantially aligned with the second opening 602 of the outer case 106.

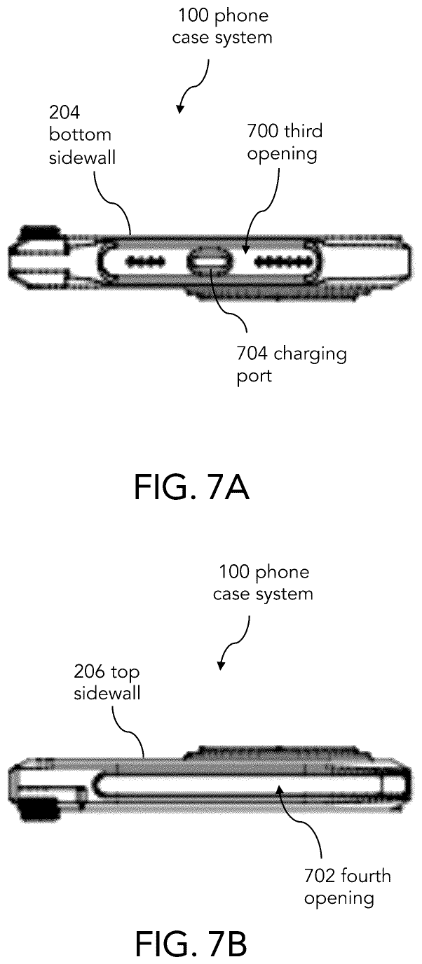

FIGS. 7A and 7B illustrate bottom and top views, respectively, of the phone case system 100. In some embodiments, the outer case 106 includes a third opening 700 located along the bottom sidewall 204, as shown in FIG. 7A, and a fourth opening 702 located along the top sidewall 206, as shown in FIG. 7B. The third opening 700 may be configured to enable the user to access the charging port 704 of the mobile phone 102. In some embodiments, the third opening 700 is configured to enable the user to access the charging port 704 and/or a headphone jack(s), a switch(es), and a button(s). The fourth opening 702 may be configured to allow signal access to internal components of the mobile phone 102, such as for signal reception. The fourth opening 702 may also be configured to reduce the weight of the phone case system 100, and also may aid in shock absorption of the outer case 106.

Though not shown in the figures, the inner case 104 may also include a third opening configured to enable the user to access the charging port 704 and any other components located along a bottom portion of the mobile phone 102. The inner case 104 may also include a fourth opening similar to the fourth opening 702 of the outer case 106. In some embodiments, the third opening of the inner case 104 is substantially aligned with the third opening 700 of the outer case 106. The fourth opening of the inner case 104 may be substantially aligned with the fourth opening 702 of the outer case 106.

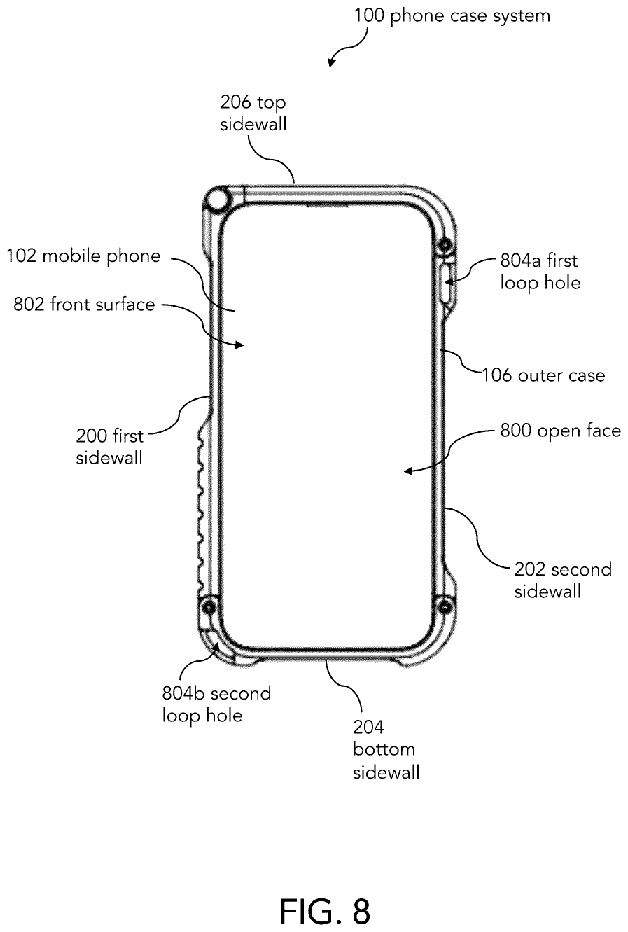

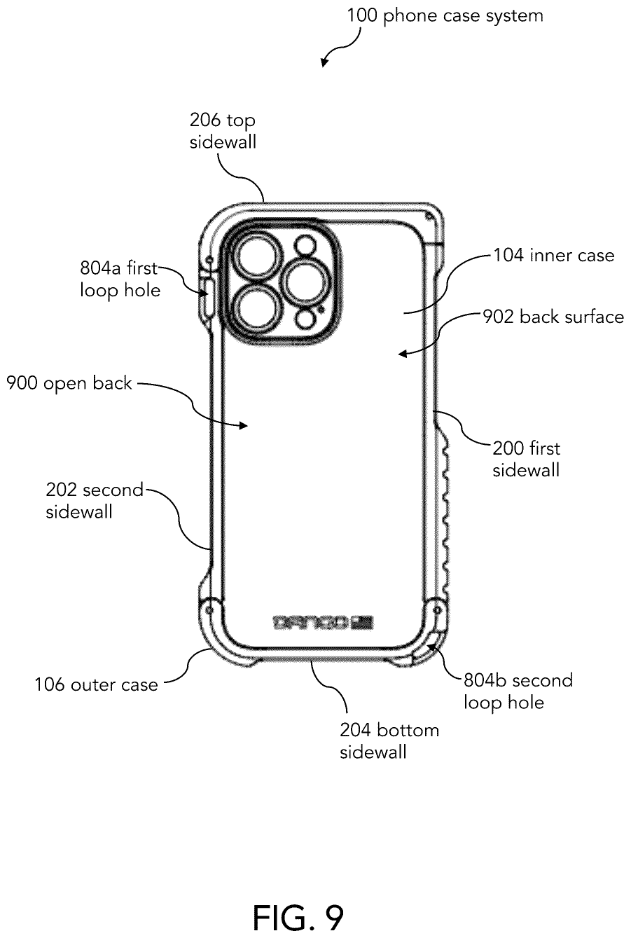

FIG. 8 illustrates a front view of the phone case system 100. In some embodiments, the outer case 106 defines an open face 800, as shown in FIG. 8. The open face 800 may be configured to enable the user to contact a front surface 802 of the mobile phone 102 when the mobile phone 102 is coupled to the outer case 106. FIG. 9 is similar to FIG. 8, but shows a back view of the phone case system 100. As illustrated, the outer case 106 may define an open back 900, thereby allowing the user to contact a back surface 902 of the inner case 104. FIGS. 8 and 9 together illustrate that, in some embodiments, when the mobile phone 102 is coupled to the inner case 104 and the inner case 104 is coupled to the outer case 106, the outer case 106 is configured to substantially enclose a first side, a second side, a bottom portion, and a top portion of the inner case 104. Stated another way, the outer case 106 may be thought of as forming a cage around a perimeter of the inner case 104.

FIGS. 8 and 9 also include a first loop hole 804a and a second loop hole 804b. In some embodiments, the outer case 106 includes a first loop hole 804a located along the second sidewall 202 adjacent the top sidewall 206. The outer case 106 may also include a second loop hole 804b located along the bottom sidewall 204 adjacent the first sidewall 200. In some embodiments, the first loop hole 804a and the second loop hole 804b are each configured to receive at least one object such as a keyring, a lanyard, a tether, a clip, a carabiner, and the like, thereby coupling the at least one object to the outer case 106. The outer case 106 may comprise fewer than two loop holes. In some embodiments, the outer case 106 comprises more than two loop holes. Either or both of the first loop hole 804a and the second loop hole 804b may be located along the outer case 106 in a location other than what is shown in the figures and described herein.

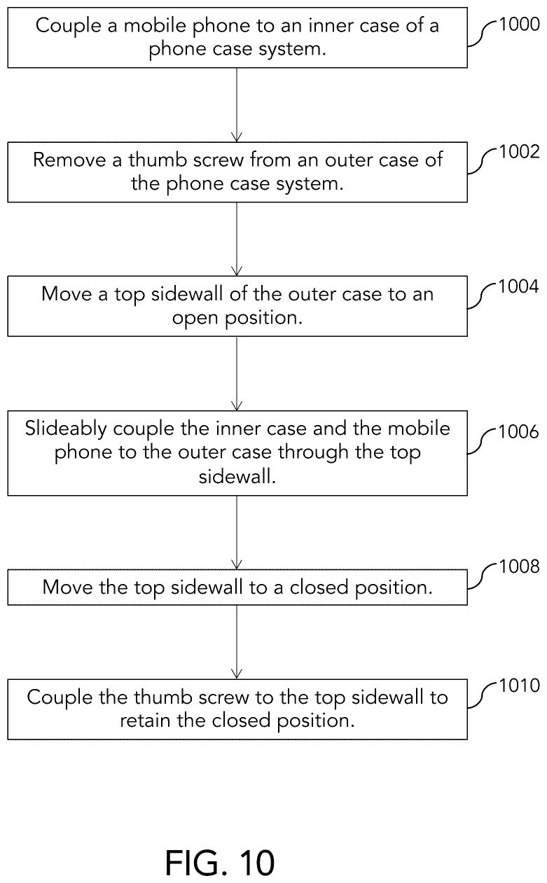

FIG. 10 illustrates a method of using the phone case system 100. In some embodiments, the method begins with coupling the mobile phone 102 to the inner case 104 of the phone case system 100, at step 1000. The mobile phone 102 may be configured to couple to the inner case 104 via a friction or “press” fit, where the inner case 104 flexes slightly to receive the mobile phone 102, then takes its normal size and/or shape to retain the mobile phone 102. The method may continue with removing the thumb screw 300 from the outer case 106, at step 1002. In some embodiments, the next step is to move the top sidewall 206 of the outer case 106 to the open position 208, at step 1004 (and also as illustrated in FIG. 2). The method may continue with slideably coupling the inner case 104 and the mobile phone 102 to the outer case 106 through the top sidewall 206, at step 1006. In some embodiments, the method continues with moving the top sidewall 206 to the closed position 302, at step 1008, and coupling the thumb screw 300 to the top sidewall 206 to retain the closed position 302, at step 1010 (and as shown in FIGS. 3 and 4).

In some embodiments, the inner case 104 is comprised of a thin, flexible material. The inner case 104 may be comprised of a polymer material. In contrast, the outer case 106 may be comprised of a thicker, rigid material such as hard thermoplastic, metal, or a combination of the two. The inner case 104 may be configured to protect the mobile phone 102 from the outer case 106 by providing a barrier between the mobile phone 102 and the hard, potentially abrasive material(s) of the outer case 106.

None of the steps described herein is essential or indispensable. Any of the steps can be adjusted or modified. Other or additional steps can be used. Any portion of any of the steps, processes, structures, and/or devices disclosed or illustrated in one embodiment, flowchart, or example in this specification can be combined or used with or instead of any other portion of any of the steps, processes, structures, and/or devices disclosed or illustrated in a different embodiment, flowchart, or example. The embodiments and examples provided herein are not intended to be discrete and separate from each other.

The section headings and subheadings provided herein are nonlimiting. The section headings and subheadings do not represent or limit the full scope of the embodiments described in the sections to which the headings and subheadings pertain. For example, a section titled “Topic 1” may include embodiments that do not pertain to Topic 1 and embodiments described in other sections may apply to and be combined with embodiments described within the “Topic 1” section.

The various features and processes described above may be used independently of one another, or may be combined in various ways. All possible combinations and subcombinations are intended to fall within the scope of this disclosure. In addition, certain method, event, state, or process blocks may be omitted in some implementations. The methods, steps, and processes described herein are also not limited to any particular sequence, and the blocks, steps, or states relating thereto can be performed in other sequences that are appropriate. For example, described tasks or events may be performed in an order other than the order specifically disclosed. Multiple steps may be combined in a single block or state. The example tasks or events may be performed in serial, in parallel, or in some other manner. Tasks or events may be added to or removed from the disclosed example embodiments. The example systems and components described herein may be configured differently than described. For example, elements may be added to, removed from, or rearranged compared to the disclosed example embodiments.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations and so forth. Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require at least one of X, at least one of Y, and at least one of Z to each be present.

The term “and/or” means that “and” applies to some embodiments and “or” applies to some embodiments. Thus, A, B, and/or C can be replaced with A, B, and C written in one sentence and A, B, or C written in another sentence. A, B, and/or C means that some embodiments can include A and B, some embodiments can include A and C, some embodiments can include B and C, some embodiments can only include A, some embodiments can include only B, some embodiments can include only C, and some embodiments can include A, B, and C. The term “and/or” is used to avoid unnecessary redundancy.

The term “substantially” is used to mean “completely or nearly completely.” For example, the disclosure includes “The first opening of the inner case may be substantially aligned with the first opening of the outer case . . . .” In this context, “substantially aligned” is used to mean that the first opening of the inner case may be “completely” or “nearly completely” aligned with the first opening of the outer case. The use of the term “substantially aligned” is not meant to imply that the first openings of each case are the same size, just that at least some portion of the openings are aligned. For example, the first opening of the outer case may be larger than the first opening of the inner case while still being “substantially aligned” with the first opening of the inner case.

The term “adjacent” is used to mean “next to or adjoining.” The disclosure includes “ . . . the outer case 106 includes a first loop hole 804a located along the second sidewall 202 adjacent the top sidewall 206 . . . .” In this context, “adjacent the top sidewall” is used to mean that the first loop hole is located “next to” or “adjoining” the top sidewall.

The terms “thin” and “thicker” are relative terms used to describe the relative thicknesses of the inner case 104 and outer case 106, respectively. For example, the disclosure includes “In some embodiments, the inner case 104 is comprised of a thin, flexible material . . . . In contrast, the outer case 106 may be comprised of a thicker, rigid material . . . .” In this context, “thin” may be used to mean a material defining a thickness of less than 1 mm to about 3 mm, and “thicker” may be used to mean a material defining a thickness greater than about 3 mm.

While certain example embodiments have been described, these embodiments have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions, and changes in the form of the methods and systems described herein may be made without departing from the spirit of the inventions disclosed herein.

We claim:

1. A phone case system, comprising:
an inner case configured to receive a mobile phone, the inner case comprising a flexible material configured to substantially surround a perimeter and a back surface of the mobile phone; and
an outer case configured to receive the mobile phone and the inner case, the outer case comprising a rigid material, wherein the outer case defines:
a first sidewall;
a second sidewall located opposite the first sidewall;
a bottom sidewall extending between the first sidewall and the second sidewall; and
a top sidewall located opposite the bottom sidewall and extending between the first sidewall and the second sidewall, the top sidewall comprising a first end and a second end located opposite the first end, wherein the second end of the top sidewall is hingedly coupled to the second sidewall and wherein the first end of the top sidewall is configured to move between an open position and a closed position to receive and retain the mobile phone within the outer case.

2. The phone case system of claim 1, further comprising a thumb screw configured to detachably couple the first end of the top sidewall to a first end of the first sidewall.

3. The phone case system of claim 2, further comprising a plurality of mechanical fasteners configured to:
couple the second end of the top sidewall to a first end of the second sidewall,
couple a second end of the second sidewall to a first end of the bottom sidewall, and
couple a second end of the bottom sidewall to a second end of the first sidewall.

4. The phone case system of claim 3, wherein the plurality of mechanical fasteners comprise a plurality of hinge pins.

5. The phone case system of claim 1, wherein the first sidewall includes a ridged portion configured to allow a user to hold the outer case.

6. The phone case system of claim 1, wherein the first sidewall includes a plurality of ridges configured to allow a user to hold the outer case.

7. The phone case system of claim 1, wherein the inner case comprises:
a first opening located on a first portion of the inner case;
a second opening located on a second portion of the inner case, wherein the second portion is located opposite the first portion; and
a third opening located on a bottom portion of the inner case,
wherein the first opening and the second opening are configured to enable a user to access a plurality of buttons of the mobile phone, and
wherein the third opening is configured to enable the user to access a charging port of the mobile phone.

8. The phone case system of claim 7, wherein the outer case comprises:
a first opening located on the first sidewall of the outer case;
a second opening located on the second sidewall of the outer case; and
a third opening located on the bottom sidewall of the outer case,
wherein the first opening and the second opening are configured to enable the user to access the plurality of buttons of the mobile phone, and
wherein the third opening is configured to enable the user to access the charging port of the mobile phone.

9. The phone case system of claim 8:
wherein the first opening of the inner case is substantially aligned with the first opening of the outer case,
wherein the second opening of the inner case is substantially aligned with the second opening of the outer case, and
wherein the third opening of the inner case is substantially aligned with the third opening of the outer case.

10. The phone case system of claim 9, further comprising a fourth opening located along the top sidewall of the outer case.

11. The phone case system of claim 7, wherein when the mobile phone is coupled to the inner case and the inner case is coupled to the outer case, the outer case is configured to substantially enclose at least the first portion, the second portion, the bottom portion, and a top portion of the inner case.

12. The phone case system of claim 11, wherein the top portion of the inner case is located opposite the bottom portion of the inner case.

13. The phone case system of claim 11, wherein the outer case defines an open face, thereby allowing the user to contact a front surface of the mobile phone.

14. The phone case system of claim 11, wherein the outer case defines an open back, thereby allowing the user to contact a back surface of the inner case.

15. The phone case system of claim 1, further comprising a first loop hole located along the second sidewall adjacent the top sidewall and a second loop hole located along the bottom sidewall adjacent the first sidewall.

16. The phone case system of claim 15, wherein the first loop hole and the second loop hole are each configured to receive an object selected from the group consisting of a keyring, a lanyard, a tether, and combinations thereof.

17. The phone case system of claim 1, wherein the inner case comprises a polymer material.

18. The phone case system of claim 1, wherein the outer case comprises a combination of metal and plastic materials.

19. A method of using a phone case system, the method comprising:
coupling a mobile phone to an inner case comprising a flexible material configured to substantially surround a perimeter and a back surface of the mobile phone; and
coupling the inner case and the mobile phone to an outer case comprising a rigid material, wherein the outer case defines:
a first sidewall;
a second sidewall located opposite the first sidewall;
a bottom sidewall extending between the first sidewall and the second sidewall; and
a top sidewall located opposite the bottom sidewall and extending between the first sidewall and the second sidewall, the top sidewall comprising a first end and a second end located opposite the first end, wherein the second end of the top sidewall is hingedly coupled to the second sidewall and configured to move between an open position and a closed position to receive and retain the mobile phone within the outer case.

20. The method of claim 19, wherein coupling the inner case and the mobile phone to the outer case comprises:
moving the top sidewall to the open position;
slideably coupling the inner case and the mobile phone to the outer case through the top sidewall such that the inner case and the mobile phone are substantially encased by the first sidewall, the second sidewall, and the bottom sidewall; and
moving the top sidewall to the closed position,
wherein moving the top sidewall from the open position to the closed position comprises using a thumb screw to detachably couple the first end of the top sidewall to a first end of the first sidewall, and wherein moving the top sidewall from the closed position to the open position comprises removing the thumb screw from the first end of the top sidewall and the first end of the first sidewall.
